(19) United States
(12) Patent Application Publication
(10) Pub. No.: US 2005/0180390 A1
(43) Pub. Date: Aug. 18, 2005

(54) Method to provide cost-effective migration of call handling from a legacy network to a new network

(76) Inventors: Ronald Baruzzi, Tinton Falls, NJ (US); Kenneth Cinque, Somerset, NJ (US); Kenneth C. Gibbons, Shrewsbury, NJ (US); Gary Munson, Little Silver, NJ (US); Peter L. Ng, Freehold, NJ (US)

Correspondence Address: AT&T CORP., P.O. BOX 4110, MIDDLETOWN, NJ, 07748, US

(21) Appl. No.: 10/782,589

(22) Filed: Feb. 18, 2004

(51) Int. Cl. H04L 12/28

(52) U.S. Cl. 370/351

(57) ABSTRACT

A method is provided for selectively guiding calls from a legacy network into a new network for service processing there. The methodology allows a less costly transition from a legacy network to a new network as the overall network evolves.

### BACKGROUND OF THE INVENTION

As a switched telecommunication networking system evolves over time, there is the possibility of having legacy networks being connected to and eventually replaced by new types of networks. These new networks may have different equipment, architectures, and capabilities. Over a transition period from legacy network to new network, some portion of calls will continue to enter the legacy network. Transition costs can be reduced or better managed by selecting, at any given point in time, which of those calls should be guided to the new network for service processing to be performed there, and which should still have service processing performed by the legacy network. Furthermore, the transition to the new network may take a significant period of time and, in fact, may be spread over several years, or remnants of the old network may coexist for an indefinite period of time.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a layout of a section of a telecommunications network system according to one embodiment of this invention;

FIG. 2 is a layout showing in more detail a representative network system according to an embodiment of this invention.

FIG. 3 is a layout showing in more detail a representative network system according to an embodiment of this invention.

FIG. 4 is a layout showing in more detail a representative network system according to an embodiment of this invention.

### DETAILED DESCRIPTION OF THE INVENTION

In an embodiment of this invention, transition costs are lessened by reducing the time span over which network resources (for example adjuncts) must exist in both networks to provide feature parity. Further, in one embodiment of this invention, transition costs are lessened by deciding which calls are to be handled by the new network at any given point in time based upon efficiency criteria (e.g., how many switches in the old network a call has to be routed through in order to reach the new network, or whether the new network affords a less expensive means of support for a given service). Further, transition costs can be managed by gating the call volume for the new network, depending upon the amount of resources available in that new network, and which could be done for any given service.

Further, in yet another embodiment of this invention where the new network supports equipment from multiple vendors that is not identical in functionality, transition costs can be lessened by targeting a particular type of element in the new network for invoking service processing (e.g., any switch from Vendor A) or even a particular element (e.g., network switch #12). Therefore, feature parity is not required within a multi-vendor new network environment.

Further, in yet another embodiment of this invention, transition costs can be reduced by implementing new features only in the new network, thereby avoiding throw-away development and resources in the legacy network.

Furthermore, each of those aspects can be combined into one type of embodiment of this invention, or various levels and advantages can be present in any of the embodiments.

As telecommunication networks evolve over time and as new networks are deployed there may be periods of time when a major shift in the capabilities of the various networks, or shifts in the equipment or technology occur. For example, the AT&T long distance network is shifting from a 4ESS-based network to a 5ESS and DMS250 “Edge Switch”-based network. As another example, the AT&T long distance TDM network (4ESS and Edge Switch-based) is also shifting to a VoIP-based network. Not only may the switching equipment in these networks change, the associated service processing architecture and elements and their capabilities may also change. Typically, the old and new networks are connected. When a call enters the legacy network from, e.g., a switched access or nodal customer, decision criteria can be applied as to whether service processing for this call should be handled in the legacy network or in the new network. If the decision is the latter, i.e., the new network, a mechanism must be provided for guiding the call to the new network along with the necessary related information, as well as a mechanism for invoking service processing in the new network. A decision system is provided in the legacy network that determines, for a call entering that network, whether service processing should be performed in the legacy network or the new network.

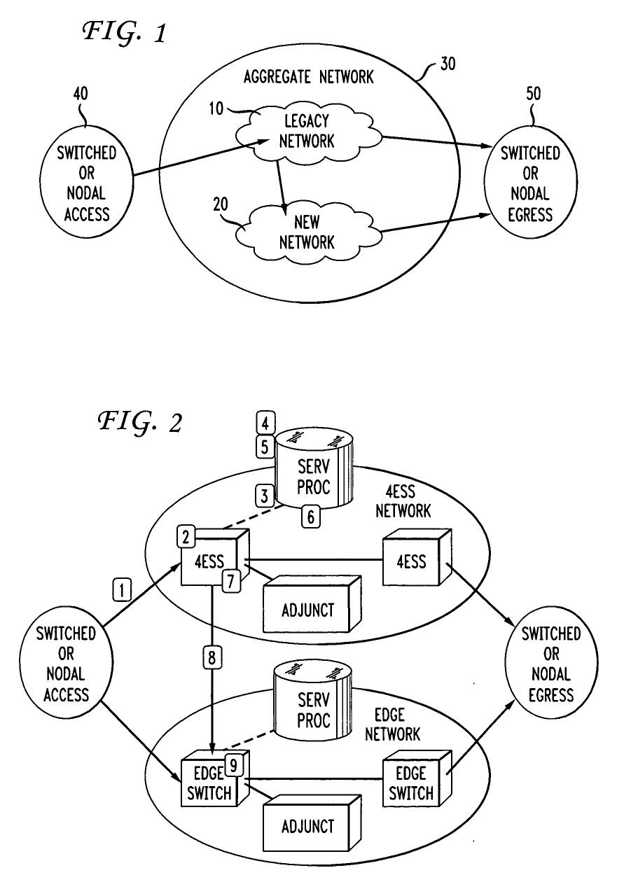

Each network can include, generally speaking, switches, adjuncts, service processors and other elements. Within the context of our invention the new network 20 and the legacy network 10 of FIG. 1 must be interconnected and those two “sub networks” are parts of one telecommunication system or aggregate telecommunication network. The new network 20 may, for example, consist of different types of switch equipment from multiple vendors whose capability sets may or may not be identical to the legacy network 10 or even other parts of the new network 20. Likewise for the service processor, adjunct and other equipment in these networks. The total “network” is then considered 30, with calls “originating” into that network at point 40 and egressing that network at 50. Calls may originate and terminate, for example, through other networks to/from directly-connected customers (here referred to as Nodals).

The architecture or equipment for supporting a service in the legacy network 10 and the architecture or equipment for supporting the same service in the new network 20 in one embodiment of this invention do not have to be the same. Calls may also access the new network directly for processing there.

The switch elements in a network may be used for connection control and routing of calls, interacting with service processors, billing and the like. In, for example, a VoIP network when interfacing to a TDM network the switch generally has two components: a gateway that provides for the TDM-IP conversion and a softswitch. The softswitch may go by various names, and it may be centralized or distributed and may have several variations. In the AT&T VoIP architecture, the Call Control Element is roughly analogous to a softswitch.

The adjuncts in a network are used to provide a variety of service capabilities; for example announcement prompts and menus, information collection from the caller through DTMF or speech recognition, and bridging for multi-party conferencing. Adjuncts may also contain actual service logic—i.e., perform the service processor function. An adjunct may have a proprietary interface, such as the AT&T Network Adjunct Platform for Megacom800 Transfer Connect Service or the AT&T Consumer Long Distance Adjunct for Consumerl+long distance features hosted by the 4ESS switch, or it may appear as an Advanced Intelligent Network (AIN) Intelligent Peripheral or Service Node element. In a VoIP network, an adjunct is a Media Server.

The service processors that are employed generally contain call processing logic and data for specific services and features, and interact with the switches and adjuncts, for example, a Network Control Point (NCP) in the AT&T 4ESS network or an AIN Service Control Point (SCP) in the AT&T Edge network. In a VoIP network, a service processor is generally referred to as an Application Server.

When a migration from a legacy network 10 occurs the goal may be to eventually migrate access and support for all calls from the legacy network 10 to a new network 20 and retire the old network equipment (as in the case of, for example, migration from an AT&T 4ESS network to an AT&T Edge network), or to transition handling of a given type of call from the legacy network to the new network (as may be the case, for example, of PrePaid Card service from the AT&T 4ESS/Edge TDM network to an AT&T VoIP network). Furthermore, the transition may not be completed for many years in that available funding for the networks, the planning, the operation resources or the like may be limited.

Practical considerations may require or even dictate that some or all of the calls continue to enter the aggregate network by way of the legacy network as opposed to the new network for some period of time. Consequently, it can be advantageous to decide whether service processing should be performed by the legacy network or the call guided to the new network and the service processing performed there. By intelligently making this decision it may be possible to provide a more economical and timely transition from the legacy network to the new network.

Further, service support for a call may be handled only in the new network because the given service or feature is only available within the new network for economic reasons. For example, the network provider does not have to maintain feature parity between the two networks and can force earlier retirement of old adjunct or service processor equipment in the legacy network, and possibly associated old operations support systems as well. Or, for example, the method of supporting a specific service in the new network may be less expensive than in the legacy network. Further, by providing a decision mechanism, the growth of additional resources for a service can occur all in the new network or can be balanced between the new network and the legacy network.

The methodology of one embodiment of this invention applies decision criteria for deciding which calls should be handled in the new network, guidance of those calls from the legacy network into the new network with related information, and invocation of service processing in the new network.

Various decision criteria may be used either alone or in any combination to determine if the call should be handled by the new network instead of the legacy network. For example, the service or feature set within a service or collection thereof, the customer, the originating switch ID, the ANI/Calling Party Number, the Called Party Number or Original Dialed Number, a percent of allocation between the two networks, the level of usage of the two networks, the incoming trunk-group ID or type, the existence of a qualified routing plan to send a call into the new network, on/off toggle administrable from a work center, maintenance levels of the two systems or other criteria. These criteria may involve any combination of the above types of data as well as other data and may be incorporated into existing service logic such as AT&T 8YY service or AT&T Consumer Long Distance service.

A routing plan consists of service logic e.g., in the form of a decision graph used or selected for use in the processing of a given type of call such as an 8YY call. A routing plan contains all of the features that may be used in subsequent call processing and is given a label at the time that it is created that indicates whether or not it qualifies for use in sending calls to the new network for processing. As indicated in [0022] above, the qualification of the routing plan selected to process a given call is used in determining which calls to send to the new network for processing. A routing plan is a qualified plan if all the features contained in the plan logic are supportable in the new network and if it contains one or more specific features, (e.g., Transfer Connect Service) that serve as the driver for sending the call to the new network for processing.

When the call is sent to the new network, guidance of the call may use a special routing number, such as a specific AT&T Private Number (APN) or Special Service Code (SSC number). Further, a routing number may be chosen based on the particular originating switch in the old network in order to route to a switch in the new network that is close in proximity to the one in the old network or otherwise advantageous from a routing or call processing standpoint. The routing number may or may not identify a particular switch in the new network at which service processing is to be invoked, or implicitly the switch of a particular type may be selected based upon this identification. Guidance information may be something other than or in addition to a special routing number. For example, it could be a type of network identifier such as a pseudo Carrier Identification Code that identifies the new network as the call destination from the legacy network's point of view. Further, an individual call to be processed in the new network may use the same trunks and transport resources from the legacy network to the new network being used for call completion. All information available to the legacy network (for example the Called Party Number, the ANI, OLI digits or the like) for service processing would also be provided to the new network for service processing. Service processing in the new network may require information to be looked for in different places in signaling messages than in the old legacy network. For example, the ISUP “Called Party Number” parameter may contain the originally dialed 8YY number when the call entered the legacy network, whereas that originally dialed number may be contained in the ISUP Original Dialed Number parameter when the call is guided to the new network.

Invocation of service processing in the new network would generally be based on content of the signaling information passed from the legacy network, such as the specific routing number or type of routing number or other guidance-related information, or some other parameters whose values explicitly or implicitly cause service invocation; or possibly on dedicated trunks or channels over which the calls are received; or some combination thereof. The invocation of service processing does not necessarily require any new functionality in the new network that it would not already have. For example, for AT&T Megacom800 Transfer Connect Service on shared intertoll trunk calls from the 4ESS network to the Edge network, the AIN Dialed Number Trigger can be set to trigger on the called party number if it's an 8YY number, which is an industry AIN capability. Or, for example, for PrePaid Card service using a new VoIP network, the Call Control Element/softswitch would be queried by the originating Gateway for every new call and the CCE would trigger invocation of a particular Application Server based upon the specific called party number, which are industry VoIP capabilities. However, invocation of call processing in the new network could also be based on new capabilities in the new network, such as signaling information from the legacy network that explicitly is an instruction to the new network to invoke service processing.

### FIG. 2

### EXAMPLE 1

Call Setup.

An exemplary call flow from, for example, the AT&T 4ESS legacy network to the new AT&T Edge network for Megacom800 Transfer Connect Service will now be described with reference to FIG. 2.

In step 1 an 8YY call arrives at an originating 4ESS over either a switched-access or nodal trunk.

In step 2 a conventional 8YY query processing is performed with a following addition: the 4ESS includes an optional parameter (i.e., the Inbound Supplemental Originating Information parameter) in the query message sent to the Service Processor (NCP) that indicates whether or not the call arrived on a trunk that qualifies for call handling in the new network. Population of that optional parameter is dependent upon attributes of the incoming switch trunk group.

In step 3 the query message is routed to the appropriate 8YY Service Processor based on the 8YY dialed number as today.

In step 4 the Service Processor consults 8YY service logic. If it is determined that the call originates at the 4ESS on a “qualified” trunk, that the 8YY number is marked for call handling in the new network, and that the call fully qualifies to receive Transfer Connect Service in the Edge network, the Service Processor attempts to send the call into the new network for handling. (If not, the call is processed in the normal fashion within the 4ESS network.) The Service Processor may also allocate some percentage of calls meeting the above criteria for handling in the new (Edge) network.

It should be noted that in the case of Transfer Connect Service, the 8YY support system examines 8YY Service Logic when it provisions the Service Processor and determines at that time if calls to a specific 8YY number are eligible for processing by Transfer Connect Service logic in the Edge network. The support system uses various criteria (such as a qualified routing plan) to determine this eligibility, such as: (1) all of the features within a specific 8YY Service Logic are supported by the Edge network and (2) if this logic is invoked, then it is possible that it will terminate at a destination that uses Transfer Connect Service. (Because 8YY service processing may in part be determined by caller-entered information as part of a service interaction with the caller, or originating location, or time of day, etc., it may not be known a priori whether a given call will actually involve the Transfer Connect Service feature.)

In step 5 after the Service Processor determines that an attempt should be made to send the call into the new network for handling, it consults a special routing table to obtain the network address (in the form, e.g., of a routing number) of the Edge Switch that has been designated to process the call. The table is arranged to associate an Edge Switch network address with each 4ESS in the legacy network, where for example the 4ESS is identified by its SS7 Origination Point Code. (If the table does not contain an entry for the originating 4ESS in question, the attempt to send the call into the new network for handling is abandoned and the call is processed in the normal fashion within the 4ESS network.) The Edge Switch network addresses in the table could be administered to target specific Edge Switches, or a specific type of Edge Switch.

In step 6 the Service Processor then sends a response message to the 4ESS with instructions to route the call to the provided routing number corresponding to the Edge Switch designated to receive the call.

In step 7 the originating 4ESS executes the routing instructions in the normal fashion using existing switch translations. The 4ESS associates a unique Class of Service with the call based upon the routing number provided.

In step 8 the call is routed to the designated network address in the normal fashion on existing trunks that are shared with other traffic. Because of the unique Class of Service associated with the call, the last 4ESS in the call path, where the call is delivered to the Edge network, substitutes the originally dialed 8YY number for the routing number. That 8YY number along with ANI and Originating Line Information (OLI) and other information needed to process the call are signaled to the Edge Switch.

In step 9 the call arrives at the Edge Switch on a trunk group that is shared with calls of other services. The 8YY call address causes the Edge Switch to process the call using existing AIN functionality, which includes the AIN Dialed Number Trigger being set for this 8YY number. Processing of this 8YY call starts over in the Edge Switch with the sending of a query message to a Service Processor in the new network for routing and billing and other feature support instructions.

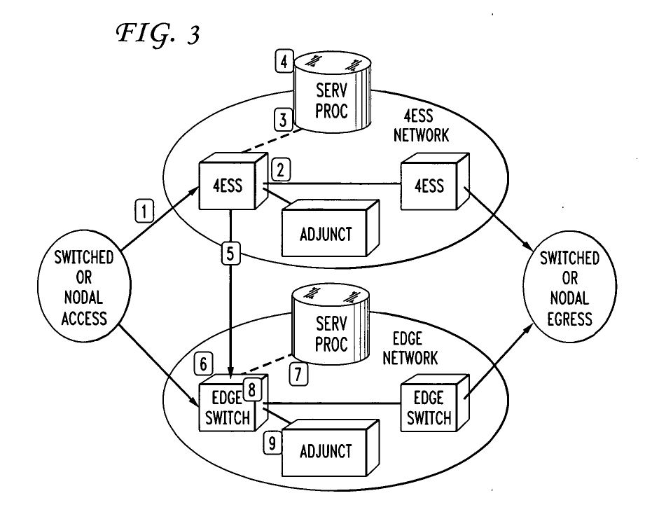

### FIG. 3

### EXAMPLE 2

Call Setup 2.

In another example, where the call flow, is for example, from the AT&T 4ESS network to the new AT&T Edge network for the Personalized Announcements feature of Consumer Long Distance service will now be described with reference to FIG. 3.

In step 1 a switched access or nodal access call enters the AT&T network at a 4ESS switch in the legacy network.

In step 2 based on, e.g., the ANI, a query is sent to a Consumer Long Distance Service Processor.

In step 3 that Service Processor receives the query and determines the features needed on the call and, based on specific decision criteria, that this call should be handled by the new network.

The decision criteria may be the specific features to be provided on the call, or other items cited above. It may include knowledge by the Service Processor that the particular announcement to be provided on that call is only loaded on adjuncts in the new network.

In step 4 the Service Processor replies to the 4ESS with an instruction to route the call to a specific routing number, for example a non-dialable Special Service Code.

In step 5 the 4ESS receives the routing instruction, routes accordingly, and naturally makes an AMA record with the SSC as routing number. 4ESS translations would be provisioned so that the SSC number points to a route to the new network. That route could be via another 4ESS.

In step 6 an Edge Switch receives the call over, e.g., a shared intertoll type of trunk. Based on some kind of trigger (e.g., the existing AIN Info Analyzed trigger detection point administered to trigger on the specific SSC number), a query is sent to a Consumer Service Processor that is part of the new network.

It should be noted that in the case of SS7 ISUP signaling and intertoll trunks, the Edge Switch would receive such data as ANI, original dialed number, Jurisdiction Information, OLI information. Also, in the case of an AIN query, the original dialed number and ANI would be sent along in the query to the Service Processor.

In step 7 the Consumer Service Processor receives the query, including relevant data such as ANI, Original Dialed Number, etc. Based on the specific routing number (SSC number), or perhaps something like the OPC of the querying switch (so that the Service Processor knows it's a new network switch), or the format of the query (AIN TCAP versus AT&T proprietary TCAP), the Service Processor knows that service processing is to be provided in the new switch network, determines that this call gets the Personalized Announcements feature, and goes on to instruct the querying Edge Switch (see step 8) what to do. Since the Personalized Announcements feature requires the use of an adjunct (see step 9), the Service Processor will provide the switch an instruction to route the call to an adjunct. The Service Processor will also instruct the Edge Switch to perform AMA recording for this call.

In step 8 the Edge Switch receives the instruction, makes an AMA record and sends the call to an adjunct, which may be hosted by that switch or a different switch.

In step 9 call processing continues by the adjunct . . . and so on.

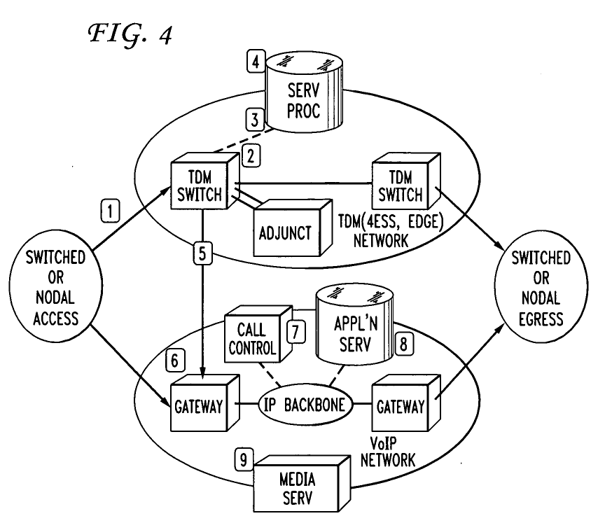

### FIG. 4

### EXAMPLE 3

Call Setup 3.

In yet another example, the call flow from the AT&T 4ESS/Edge TDM network to an AT&T VoIP network for PrePaid Card service will be described with reference to FIG. 4.

In step 1 a switched access or nodal access call enters the AT&T legacy TDM network (4ESS or Edge Switch).

In step 2 based on the 8YY Dialed Number a query is sent to a Service Processor.

In step 3 that Service Processor receives the query and determines the features needed or potentially needed on the call and, based on specific decision criteria, that this call should be handled by the new network.

The decision criteria may be the specific features, or other items cited above.

The decision criteria may also include knowledge of the identity of the originating TDM switch (for example, based on SS7 Originating Point Code), which can be used to indicate through a table in the Service Processor whether it is a TDM switch with direct connectivity to a VoIP Gateway (as opposed to having to travel through multiple TDM switches to get to a Gateway). The criteria may, for example, include a percentage allocation factor in order to not overload the finite resources in the new network as they get deployed.

In step 4 the Service Processor replies to the TDM switch with an instruction to route the call to a specific routing number, for example an AT&T Private Network (APN) number.

In step 5 the TDM switch receives the routing instruction and makes an AMA record with the APN number as routing number. The TDM switch translations would be provisioned so that the APN number points to a route to the new network. That route could be via another TDM switch.

In step 6 a Gateway receives the call over, e.g., a shared type of trunk. The Gateway queries the centralized Call Control Element (softswitch) for this new call, as it would for any incoming call attempt.

In step 7 based on the specific APN number, the Call Control Element knows to invoke the PrePaid Application Server, and does so. The PrePaid Application Server receives all the information it needs to process a new call.

In step 8 the PrePaid Card Application Server receives the query, including relevant data such as ANI, original dialed number, etc. The PrePaid Card Application Server starts its application logic. For PrePaid, that would temporarily involve causing the call talk path to go to a Media Server so a PIN and called party number can be collected from the caller.

In step 9 interacting with the Call Control Element, the Prepaid Card Application Server causes the call talk path to be sent to a Media Server. The Media Server, instructed by the Application Server, interacts with the caller to collect PIN and called party number, etc.

It should be noted that once the caller is connected to the Media Server, the Call Control Element or Gateway will mark a Call Detail Record or AMA record as answered.

Call processing continues . . . and so on.

It should be understood that the preceding shows and describes various steps as occurring sequentially, however, one of ordinary skill in the art will understand that some steps may occur simultaneously or in various orders without departing from this invention.

1. A method of processing calls in an aggregate telecommunications network having at least two sub networks, comprising the steps of:
creating a set of decision criteria, applied in said first of said at least two sub networks, that determine which calls entering said first of said at least two subnetworks should receive service processing in said second of said at least two sub networks;
for calls that are to receive service processing in said second subnetwork, guiding those calls to that subnetwork;
invoking service processing by said second of said at least two sub networks based on information provided to it with the call or on the particular or type of incoming trunk or transmission pipe the call comes in on.

2. A method as in claim 1 further comprising the step of:
providing information conveyed by signaling that accompanies the call guided from the first subnetwork to the second subnetwork that is sufficient for causing the invocation of service processing in the second subnetwork.

3. A method as in claim 1 further comprising the step of:
providing information conveyed by signaling that accompanies the call guided from the first to second subnetwork that is sufficient for supporting service processing in the second subnetwork.

4. A method as in claim 2 wherein said associated information for invoking service processing comprises:
information selected from the group of routing number, original dialed number, an explicit trigger or a combination thereof.

5. A method as in claim 1 wherein said associated information for supporting service processing is selected from the group of information available to the first subnetwork calling party number, original dialed number, routing number, charge number, Originating Line Information, Customer ID, or a combination thereof.

6. A method as in claim 1 further comprising the step of:
targeting a specific element or type of element within said second subnetwork of said at least two sub networks to invoke service processing for the call.

7. A method as in claim 6 where the selection of the specific element or type of element within said second subnetwork may be based on the location of the origination of the call into the first said subnetwork.

8. A method as in claim 1 wherein said decision criteria is selected from at least one of the group of:
service type, features potentially applicable within a given service type, called party number, original dialed number, an ID of a switch in said first of said at least two sub networks, how close the ingress switch in said first subnetwork is in terms of some proximity measure to said second subnetwork, the identity or type of the particular trunk group over which the call entered said first of said at least two subnetworks, the ANI of the call, the calling party number of the call, the current load allocation of the first of said at least two sub networks, the current load allocation of the second of said at least two sub networks, the existence of a qualifying routing plan or routing information to send a call into said second of said at least two subnetworks, an on/off toggle administrable from a work center, the type of service processor requires to handle the call or a combination thereof.

9. A method as in claim 1 wherein the guidance of calls to the second subnetwork is responsive to a routing number, a pseudo CIC code, other routing information or a combination thereof.

10. A method as in claim 6 further comprising:
identifying qualified Routing Plans and using said qualified plans in said decision step wherein the provisioning system responsible for installing Routing Plans as part of service logic examines each plan to determine its eligibility for service processing in the second subnetwork.
